(19) United States
(12) Patent Application Publication
(10) Pub. No.: US 2007/0230948 A1
(43) Pub. Date: Oct. 4, 2007

(54) Lens structure for an imaging device and method making same

(75) Inventors: Lee Hsiao-Wen, Hsinchu City (TW); Chang Chia-Yang, Jhubei City (TW)

Correspondence Address: Tung & Associates, Suite 120, 838 W. Long Lake Road, Bloomfield Hills, MI, 48302, US

(73) Assignee: VisEra Technologies Company Ltd., R.O.C.

(21) Appl. No.: 11/396,461

(22) Filed: Apr. 3, 2006

(51) Int. Cl. G03B 17/00

(52) U.S. Cl. 396/439

(57) ABSTRACT

According to the present invention, a lens structure is disclosed which comprises: a substrate; a lens on the substrate, the lens being made of a lens forming material; and a restriction structure adjacent to the lens on the substrate. By this restriction structure, the area of the lens forming material on the substrate is restricted. The thickness (and hence the optical characteristics) of the lens may thus be precisely controlled. A method for making such a structure is also disclosed.

### BACKGROUND OF THE INVENTION

1. Field of the Invention

The present invention relates to a lens structure, and particularly to a lens structure for use in a digital imaging device, and a method for making the lens structure.

2. Description of the Related Art

Digital imaging devices have been widely used in many electronic products nowadays. They are used in, for example, digital cameras, digital video recorders, cellular phones with photographing function, safety-control monitors, etc.

A digital imaging device usually includes a lens structure and an image sensing module (such as a CCD image sensor or a CMOS image sensor). The lens structure may comprise multiple lenses for fine adjustment of incident light, so that the image sensing module may better capture an image.

A conventional lens module structure is shown in FIG. 1. In this lens module structure, there are four lenses 11, 12, 13 and 14, for adjustment of incident light before it reaches a image sensing module (not shown) under the fourth lens 14. The structure provides a clear aperture 10 at the first lens 11 as an entrance for incident light, a barrel 15 to mechanically hold the structure together, and a spacer 16 to control the distance between the third lens 13 and the fourth lens 14, for better optical performance.

Another conventional lens structure and its manufacturing method are disclosed in US2006044450 (Camera device, method of manufacturing a camera device, wafer scale package), as shown in FIG. 2. FIG. 2(A) shows the conventional lens structure when it is still in its wafer form. This wafer includes multiple lens structure sets 20 each having a dual-lens structure; that is, each lens structure has a first lens 250 provided on a lens wafer 240, and a second lens 252 provided on a lens wafer 242, which are bonded together through spacers 222. The height of the spacers 222 is carefully designed to determine the distance between the two lenses for optimum optical performance. The wafer as shown in FIG. 2(A) is thereafter bonded with a sensor wafer (not shown) having image sensing modules provided thereon, and later diced into multiple imaging devices.

The process for making a wafer shown in FIG. 2(A) is as follows. Referring to FIG. 2(B), at first, a UV (ultra-violet) curable optical grade material is provided on a glass wafer, and the material is cured to form multiple lenses (but only one lens is shown in the figure). Next, as shown in FIG. 2(C), the wafer formed with a single lens layer is bonded with a glass spacer wafer having multiple spacers. Thereafter in FIG. 2(D), the finished wafer of FIG. 2(C) is bonded with another single-layer lens wafer to form a dual-lens structure.

The process and the structure shown in FIG. 2 has the following drawbacks. As shown in FIG. 2(E), in realistic case, the lens material often overflows beyond the designed lens boundary during the dispensing and UV molding process, and hence the thickness and the contour of the lens will not be exactly as designed; the focus point of the lens may shift and cause out-of-focus inaccuracy; the aberrations of the lens increase and cause camera MTF performance degradation. Furthermore, the excess lens material beneath the spacers will impact the bonding strength between the spacers and the lens wafer, and cause wafer cracking. In addition, it is more critical in lens dimension, lens shape and spacer bonding accuracy control when the lens size was designed close to sensor size for this kind of wafer level chip size camera.

### SUMMARY OF THE INVENTION

In view of the foregoing drawbacks, it is therefore an object of the present invention to provide a lens structure with precise lens thickness.

Another object of the present invention is to provide a lens structure free of any cracking issue due to lens material overflow.

A further object of the present invention is to provide a method for making a lens structure with the aforementioned features.

A still other object of the present invention is to provide an imaging device with a lens structure as above.

To achieve the above mentioned objects, the present invention proposes a lens structure which comprises: a substrate; a lens on the substrate, the lens being made of a lens forming material; and a restriction structure adjacent to the lens on the substrate. By this restriction structure, the area of the lens forming material on the substrate is restricted. The thickness (and hence the optical characteristics) of the lens may thus be precisely controlled.

The aforementioned substrate may preferably be bonded with another substrate having a lens thereon, to form a dual-lens structure. In this case, the restriction structure also serves to define the distance between the two substrates.

The restriction structure is preferably formed from a material having particles dispersed therein. The particles may be of a substantially spherical shape, a substantially oval-shape, a substantially capsule-shape, or a substantially fiber shape. The diameter of the particles determines the thickness of the restriction structure.

The present invention also proposes an imaging device, which comprises a lens structure and an image sensing module located under the lens structure for receiving light passing through the lens structure. The lens structure includes a substrate, a lens on the substrate, and a restriction structure adjacent to the lens on the substrate.

The present invention also proposes a method for making a lens structure, which comprises: providing a mold with at least one first region and at least one second region; providing a first forming material into the first region and a second forming material into the second region; and transferring the first forming material and the second forming material onto a substrate, whereby the first forming material forms a lens on the substrate and the second forming material restricts the area of the first forming material.

According to the present invention, the second forming material is preferably a liquid photopolymer material containing solid ingredients of substantially spherical-shape, substantially oval-shape, substantially capsule-shape, or substantially fiber shape.

For better understanding the objects, characteristics, and effects of the present invention, the present invention will be described below in details by illustrative embodiments with reference to the attached drawings.

### BRIEF DESCRIPTION OF THE DRAWINGS

FIG. 1 schematically shows a prior art lens structure by cross-section.

FIG. 2(A) schematically shows the cross-sectional view of a prior art lens structure at its wafer form.

FIGS. 2(B)-2(D) schematically show the prior art process for making a wafer shown in FIG. 2(A).

FIG. 2(E) schematically explains the drawbacks of the prior art structure and process.

FIG. 3 is a top view showing the first embodiment according to the present invention.

FIG. 4 is a cross-sectional view along the line x-x of FIG. 3.

FIG. 5 is a cross-sectional view showing the second embodiment according to the present invention.

FIG. 6 is a cross-sectional view showing the third embodiment according to the present-invention.

FIGS. 7(A) and 7(B) respectively show two multiple lens structures according to the present invention.

FIGS. 8(A)-(E) schematically show a process for making a lens structure according to the present invention.

FIGS. 9(A)-(E) schematically show another process for making a lens structure according to the present invention.

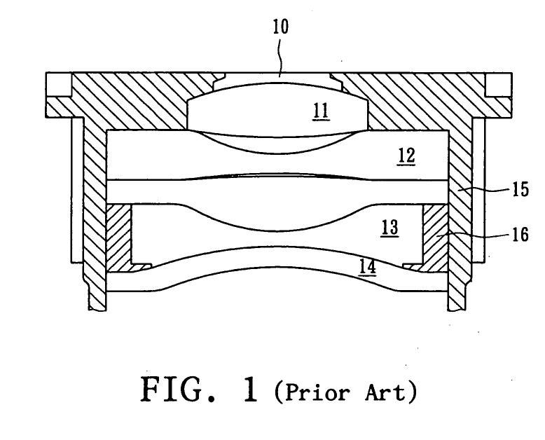

### DETAILED DESCRIPTION OF THE INVENTION

The present invention will now be described according to its preferred embodiments and drawings. The drawings are for illustrative purpose only; the diameter, thickness and width in the drawings are not drawn according to scale.

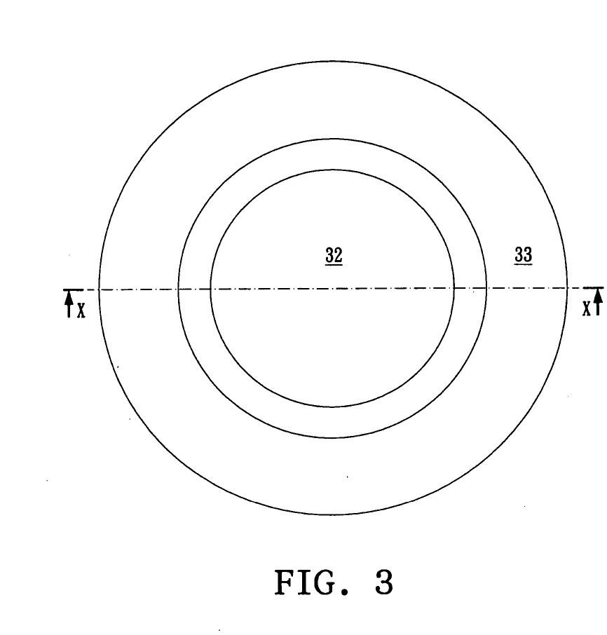

Referring to FIGS. 3 and 4, which are a top view and a cross-sectional view of the first embodiment according to the present invention, respectively, a lens structure includes a wafer substrate 31 made of a light-transparent material such as silicon glass, a lens 32 for optical purpose, and at least one restriction structure 33.

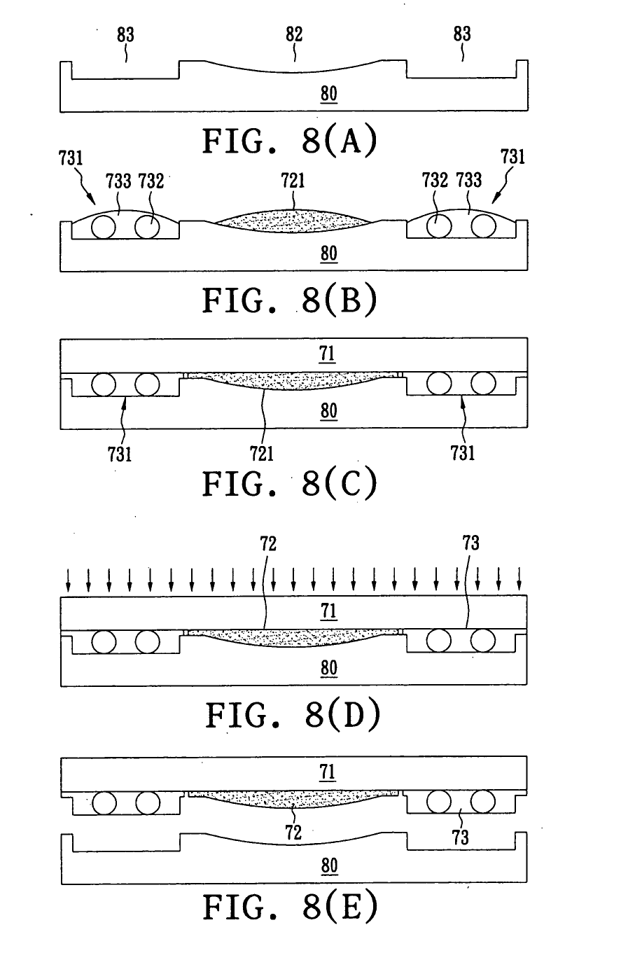

The lens 32 is formed by a lens forming material as familiar by one skilled in this art, such as a liquid photopolymer material curable under UV light. As shown in FIG. 4 (but omitted in FIG. 3 for simplicity), when forming the lens 32 on the wafer substrate 31, there may be excess forming material overflowing to the area 320 between the lens 32 and the restriction structure 33. However, the area that the forming material may flow to is restricted by the restriction structure 33; the forming material can not flow over or beyond the restriction structure 33 (nor flow under the restriction structure 33; this will be more easily understood with reference to FIG. 8 described hereinafter). Hence, the thickness of the lens 32 may be precisely controlled.

In the first embodiment shown in FIGS. 3 and 4, the restriction structure 33 has a top surface higher the center (highest) point of the lens 32. However, it is not necessarily so. Based on considerations such as economical concern, mechanical strength, yield, optical positions, lens shapes and other reasons, other arrangements are also possible.

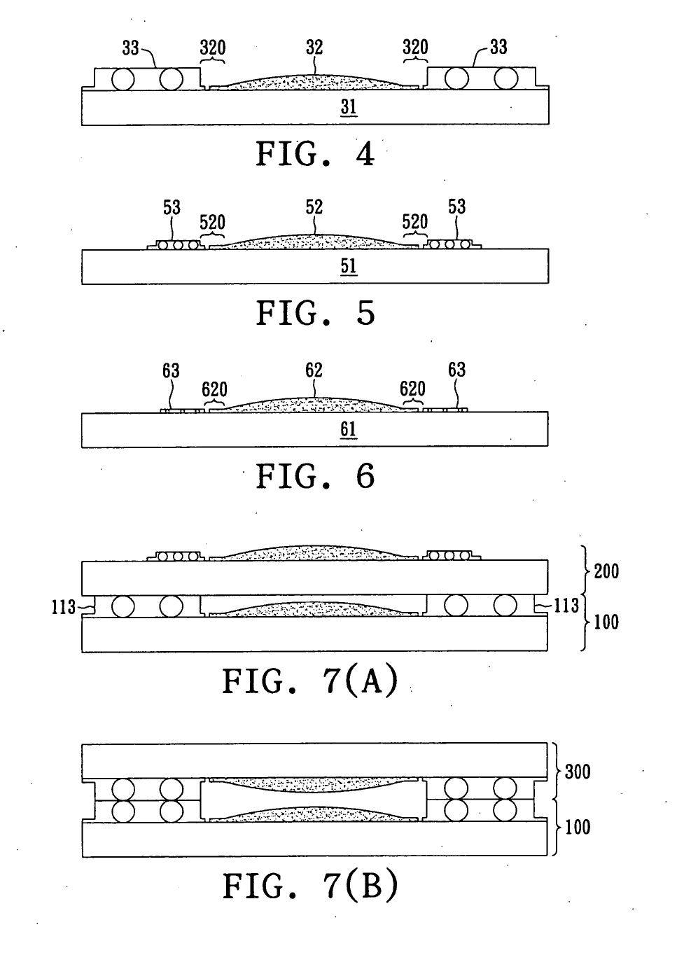

FIGS. 5 and 6 respectively show other embodiments of the present invention. The second embodiment shown in FIG. 5 differs from the first embodiment in that the thickness and width of the restriction structure 53 are smaller than that of the restriction structure 33. The top surface of the restriction structure 53 is lower than the center (highest) point of the lens 52 but higher than the top surface of the excess material area 520.

In the third embodiment shown in FIG. 6, the width of the restriction structure 63 is even smaller than that of the restriction structure 53, and the top surface of the restriction structure 63 is about level to the top surface of the excess material area 620.

The arrangements of the restriction structures 53 and 63 apparently save more material cost than that in the first embodiment. Furthermore, the die areas corresponding to the second and third embodiments are smaller than that of the first embodiment.

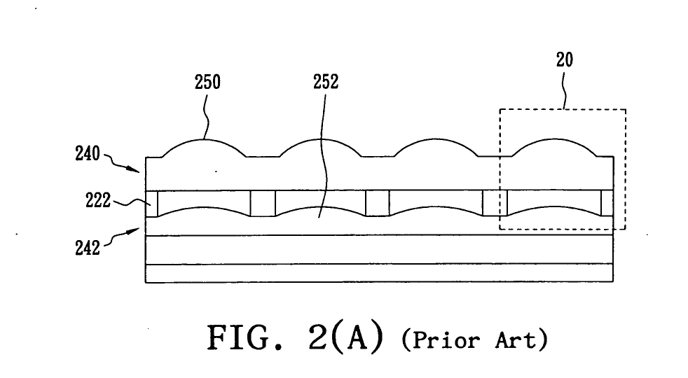

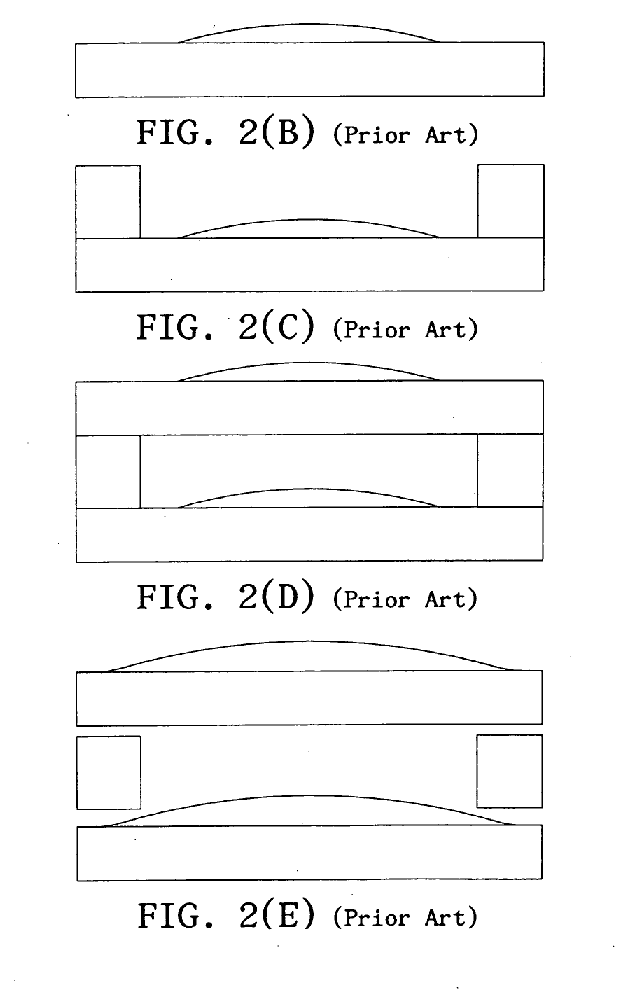

The lens structure according to the present invention may be combined with another lens structure to form a dual or multiple lens structure. Referring to FIG. 7(A), a lens structure 100 is combined with another lens structure 200 on top of the lens structure 100, so that light may pass through both lens structures for better optical characteristics. As seen from the figure, the lens structure 100 should preferably be a lens structure according to the first embodiment, so that the restriction structure 113 may serve to provide a gap and define the distance between the lower lens structure 100 and the upper lens structure 200. In this case, no additional spacers 222 such as the ones shown in the prior art (FIG. 2(A)) are required. The upper lens structure 200 may be a lens structure according to any of the embodiments.

FIG. 7(B) shows another possible arrangement for combining two lens structures. As shown in the figure, the upper lens structure 300 is combined with the lens structure 100 in a flip-side-down manner. In this case, although either of the lens structures 100 and 300 may be a lens structure according to the second or third embodiment, it is preferred that both of the lens structures 100 and 300 are the lens structure according to the first embodiment, for better alignment.

FIGS. 8(A) to 8(E) show a process for making a lens structure according to the present invention. Referring to FIG. 8(A), a mold 80 is provided which has a lens forming region 82 and at least a restriction structure forming region 83. Next, in FIG. 8(B), a lens forming material 721 is dispensed into the lens forming region 82, and a restriction structure forming material 731 is dispensed into the restriction structure forming region 83. The two dispensing steps may be done sequentially in either order or concurrently. The lens forming material 721 may be any material suitable for forming a lens, such as a liquid photopolymer material which may be cured under UV light, as familiar by one skilled in this art. The restriction structure forming material 731 according to the present invention preferably contains solid particle-like ingredients 732 dispersed in a glue-like material 733. The solid particle-like ingredients 732 may be of a substantially spherical-shape, a substantially oval-shape, a substantially capsule-shape, or a substantially fiber shape. The glue-like material is a liquid photopolymer material curable under UV light. The solid ingredients 732 help to define the thickness of the restriction structure to be formed later. The solid ingredients 732 may be made of one or more of the following materials: resins or polymers. The average cross-sectional diameter of solid ingredients 732 depends on the requirements for the lens structure design, but is typically in a range from about 0.1 μm to 350.0 μm.

Referring to FIG. 8(C), a glass wafer 71 is provided onto the mold 80, and bonded with the lens forming material 721 and the restriction structure forming material 731. As seen from the figure, due to pressure in the bonding step, some excess lens forming material and some excess restriction structure forming material may be extruded and overflow to an area between them. However, the area that the lens forming material may flow to is restricted by the restriction structure forming material 731.

Next, in FIG. 8(D), the lens forming material 721 and the restriction structure forming material 731 are exposed to UV light for curing. The lens forming material 721 and the restriction structure forming material 731 thus become solid lens 72 and restriction structure 73.

Last, as shown in FIG. 8(E), the glass wafer 71 is detached from the mold 80. Due to the steps of FIGS. 8(C) and 8(D), the pattern on the mold 80, that is, the lens 72 and the restriction structure 73, have been transferred from the mold to the glass wafer 71. Thus, a wafer with the lens structure according to the present invention has been made.

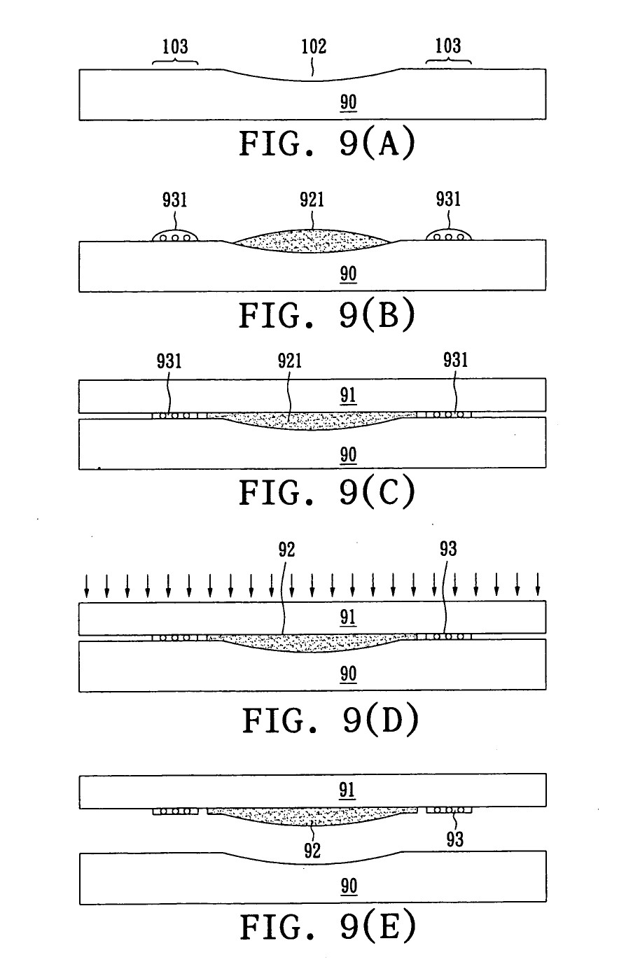

Referring now to FIGS. 9(A) to 9(E), another process for making a lens structure according to the present invention is disclosed. This process differs from the process described above in that the mold 90 is provided with only one recess region, i.e., the lens forming region 102. The mold is also provided with at least a restriction structure forming region 103, but the restriction structure forming region 103 is not recessed into the mold.

As may be readily understood from FIGS. 9(A) to 9(E), the amount of the restriction structure forming material 931 dispensed onto the restriction structure forming region 103 is less than that in the previous process embodiment, and the resultant restriction structure 93 is smaller than that formed by the previous process embodiment. The process described in FIGS. 9(A) to 9(E) may be used to make, e.g., the third structure embodiment as described in accordance with FIG. 6.

Although the present invention has been described in the above with reference to the preferred embodiments, it should be understood that the invention is not limited to the details thereof. For example, the glass wafer may be made of a material other than silicon glass, such as silicon, for infrared applications. As another example, the solid ingredients need not be perfectly aligned as arrays. As a further example, in the lens structure shown and described above, there is only one lens provided on the top surface of the substrate. However, it may be arranged so that there are two lenses on the same substrate, located on both top and bottom surfaces of the substrate. As a further other example, in FIG. 3, the restriction structure 33 is shown as a circular continuous structure with a uniform width. However, it is not necessarily so. It does not matter whether the restriction structure 33 is of a uniform width, or whether it is of a circular shape (from top view aspect), or whether it is totally continuous. The restriction structure 33 may be of an irregular width, or may be of a rectangular, square, polygon or even an irregular shape (from top view aspect), or may be only semi-continuous, that is, from top view aspect, the restriction structure 33 includes multiple subsets not connected together. In the latter case, the space between the subsets may serve as a space to accommodate the excess lens forming material. In other words, the fundamental requirement of the present invention is met as long as the excess lens material can be restricted within a predetermined area.

In addition to the above, various other substitutions and modifications will occur to those skilled in the art. Therefore, all such substitutions and modifications are intended to be embraced within the scope of the invention as defined in the appended claims.

What is claimed is:

1. A lens structure comprising:
a first substrate;
a first lens on said substrate, said first lens being made of a lens forming material; and
restriction means adjacent to said first lens on said first substrate, for restricting the area of said lens forming material on said substrate.

2. The lens structure according to claim 1, wherein said restriction means defines the thickness of said first lens by restricting the area of said lens forming material on said substrate.

3. The lens structure according to claim 1, further comprising a second substrate with a second lens provided on said second substrate, said second substrate being physically connected with said first substrate in a way that an incident light may pass through said first and second lenses, wherein said restriction means further defines the distance between said two substrates.

4. The lens structure according to claim 1, wherein said restriction means comprises at least one thickness defining element.

5. The lens structure according to claim 4, wherein said thickness defining element has a shape selected from the following group: a substantially spherical-shape, a substantially oval-shape, a substantially capsule-shape, and a substantially fiber shape.

6. The lens structure according to claim 4, wherein said thickness defining element is made of a material selected from the group consisting of: resins and polymers.

7. The lens structure according to claim 5, wherein said thickness defining element has an average cross-sectional diameter of about 0.1 μm to about 350.0 μm.

8. The lens structure according to claim 1, wherein said restriction means is formed from a liquid photopolymer in which is dispersed at least one thickness defining element.

9. An imaging device comprising:
(a) at least one lens structure including:
a first substrate,
a first lens on said substrate, said first lens being made of a lens forming material, and,
restriction means adjacent to said first lens on said first substrate, for restricting the area of said lens forming material on said substrate, and
(b) image sensing means located under said lens structure for receiving light passing through said lens structure.

10. The imaging device according to claim 9, wherein said restriction means defines the thickness of said first lens by restricting the area of said lens forming material on said substrate.

11. The imaging device according to claim 9, further comprising a second substrate with a second lens provided on said second substrate, said second substrate being physically connected with said first substrate in a way that an incident light may pass through said first and second lenses, wherein said restriction means further defines the distance between said two substrates.

12. The imaging device according to claim 9, wherein said restriction means comprises at least one thickness defining element.

13. The imaging device according to claim 12, wherein said thickness defining element has a shape selected from the following group: a substantially spherical-shape, a substantially oval-shape, a substantially capsule-shape, and a substantially fiber shape.

14. The imaging device according to claim 12, wherein said thickness defining element is made of a material selected from the group consisting of: resins and polymers.

15. The imaging device according to claim 13, wherein said thickness defining element has an average cross-sectional diameter of about 0.1 μm to about 350.0 μm.

16. The imaging device according to claim 9, wherein said restriction means is formed from a liquid photopolymer in which is dispersed at least one thickness defining element.

17. A method for making a lens structure, comprising:
providing a mold with at least one first region and at least one second region;
providing a first forming material into said first region and a second forming material into said second region; and
transferring said first forming material and said second forming material onto a substrate, whereby said first forming material forms a lens on said substrate and said second forming material restricts the area of said first forming material.

18. The method according to claim 17, wherein said second forming material comprises at least one solid particle having a shape selected from the following group: a substantially spherical-shape, a substantially oval-shape, a substantially capsule-shape, and a substantially fiber shape.

19. The method according to claim 17, wherein said element is made of a material selected from the group consisting of: resins and polymers.

20. The method according to claim 17, wherein said second forming material is a liquid photopolymer material in which is dispersed at least one substantially spherical-shape or fiber-shape element.
